(19) United States
(12) Patent Application Publication
(10) Pub. No.: US 2014/0172142 A1
(43) Pub. Date: Jun. 19, 2014

(54) Blend Plan Optimization for Not-From-Concentrate Consumable Products

(71) Applicant: THE COCA-COLA COMPANY, Atlanta, GA (US)

(72) Inventors: Jon Allen Higbie, Jr., Tyrone, GA (US); David Quinton Cross, Atlanta, GA (US); Douglas Alan Bippert, Marietta, GA (US); Sean Patrick Lennon, Atlanta, GA (US); Seon Ah Lee, Atlanta, GA (US); Timothy Allen Anglea, Windermere, FL (US)

(73) Assignee: THE COCA-COLA COMPANY, Atlanta, GA (US)

(21) Appl. No.: 13/714,605

(22) Filed: Dec. 14, 2012

(51) Int. Cl. G06F 17/50

(52) U.S. Cl. CPC G06F 17/50
USPC 700/103

(57) ABSTRACT

A blending plan for not-from-concentrate consumable products, such as liquid food and beverage products, may be optimized by utilizing a computing device executing a software algorithm. The computing device may receive inputs associated with a blending plan for the production of a consumable product over a predetermined time interval. The computing device may further apply constraints to each of the one or more inputs. The computing device may further assess penalties in a mathematical function which includes the inputs and the constraints. The function may then generate an optimized blending plan, using the applied constraints and the penalties, which minimizes costs and complexity associated with the production of the consumable product while maximizing quality.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Developing a production plan which optimizes taste and cost for food and beverage products presents unique challenges for a business unit manager. For example, the production of not-from-concentrate (“NFC”) blended liquid food and beverage products may require a business unit manager to address procurement, allocation and blending activities in view of available inventory and infrastructure limitations. Previous blending techniques do not necessarily allow the manufacturing process to be optimized in terms of utilizing components (i.e., raw materials) needed for blending to their fullest extent or in terms of maintaining a product having consistent component attribute profiles (e.g., taste, texture, shelf life and costs) despite variances in the supply and costs of the product components. It is with respect to these considerations and others that the various embodiments of the present invention have been made.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments are provided for optimizing a blending plan for not-from-concentrate consumable products. One or more inputs associated with a blending plan for the production of a consumable product over a predetermined time interval may be received by a computer. The computer may then be utilized to apply one or more constraints to each of the one or more inputs. The computer may then be utilized to assess one or more penalties in a function which includes the inputs and the constraints. The function may be utilized to generate an optimized blending plan which minimizes costs and complexity associated with the production of the consumable product while maximizing quality.

These and other features and advantages will be apparent from a reading of the following detailed description and a review of the associated drawings. It is to be understood that both the foregoing general description and the following detailed description are illustrative only and are not restrictive of the invention as claimed.

### BRIEF DESCRIPTION OF THE DRAWINGS

FIG. 1 is a block diagram illustrating a network architecture for optimizing a blending plan for NFC consumable products, in accordance with various embodiments;

FIG. 2 is a block diagram illustrating various blending plan inputs utilized in optimizing a blending plan for NFC consumable products, in accordance with various embodiments;

FIG. 3 is a block diagram illustrating constraint data utilized in optimizing a blending plan for NFC consumable products, in accordance with various embodiments;

FIG. 4 is a block diagram illustrating a computing environment which may be utilized for optimizing a blending plan for NFC consumable products, in accordance with various embodiments;

FIG. 5 is a flow diagram illustrating a routine for optimizing a blending plan for NFC consumable products, in accordance with various embodiments; and

FIG. 6 is a graphical representation of an objective function and constraints utilized by a model formulation to optimize a blending plan for NFC consumable products, in accordance with an embodiment.

### DETAILED DESCRIPTION

Embodiments are provided for optimizing a blending plan for not-from-concentrate (“NFC”) consumable products. One or more inputs associated with a blending plan for the production of an NFC consumable product over a predetermined time interval may be received by a computer. The computer may then be utilized to apply one or more constraints to each of the one or more inputs. The computer may then be utilized to assess one or more penalties in a function which includes the inputs and the constraints. The function may be utilized to generate an optimized blending plan which minimizes costs and complexity associated with the production of the NFC consumable product while maximizing quality.

In the following detailed description, references are made to the accompanying drawings that form a part hereof, and in which are shown by way of illustrations specific embodiments or examples. These embodiments may be combined, other embodiments may be utilized, and structural changes may be made without departing from the spirit or scope of the present invention. The following detailed description is therefore not to be taken in a limiting sense, and the scope of the present invention is defined by the appended claims and their equivalents.

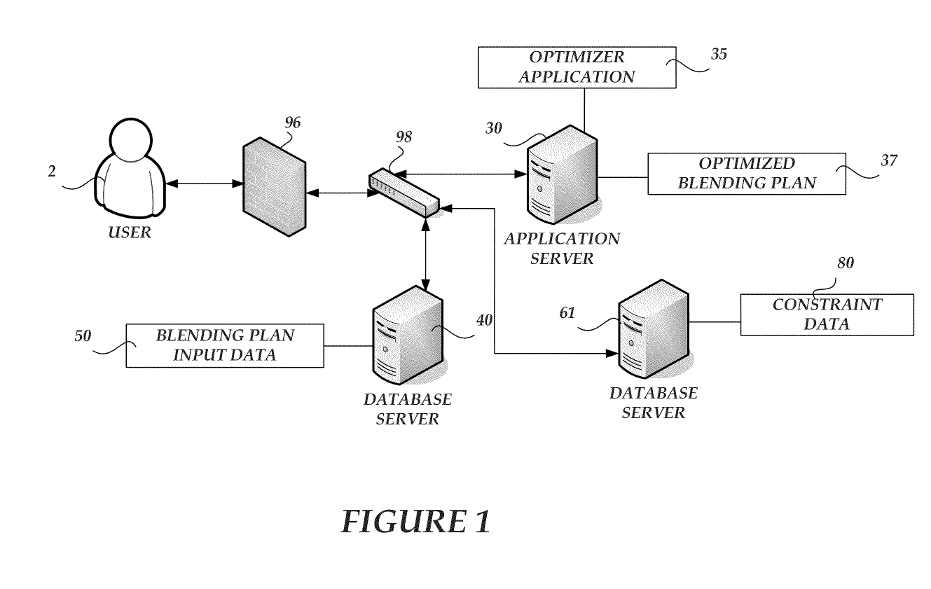

Referring now to the drawings, in which like numerals represent like elements through the several figures, various aspects of the present invention will be described. FIG. 1 is a block diagram illustrating a network architecture for optimizing a blending plan for NFC consumable products, in accordance with various embodiments. The network architecture includes a user 2 in communication with an application server 30 and database servers 40 and 61, through firewall 96 and network switch 98. In accordance with an embodiment, the user 2 may comprise a user of a networked client computing device for executing optimizer application 35 which is hosted by the application server 30. As will be described in greater detail herein, the optimizer application 35 may be utilized for generating an optimized blending plan 37 for NFC consumable products over a user-configurable time interval (i.e., a blending plan period). Examples of NFC liquid food and beverage products consistent with the various embodiments described herein may include, without limitation, fruit juices (e.g., orange juice, apple juice, etc.) such as the SIMPLY brand of NFC fruit juices which are marketed by THE COCA-COLA COMPANY of Atlanta, Ga., liquid dairy products (e.g., milk) and liquid food products (e.g., yogurt, soup, etc.). It should be understood that the optimizer application 35 may also be utilized to optimize blending plans for other types of consumable products without departing from the spirit and scope of the embodiments described herein.

In accordance with an embodiment, the optimizer application 35 may utilize blending plan input data 50 (which may be stored on the database server 40) and apply constraint data 80 (which may be stored on the database server 61) to generate the optimized blending plan 37. It should be understood that in generating the optimized blending plan 37, the optimizer application 35 may utilize a mathematical model formulation comprising an objective function which may assess various “penalties” to ensure that various requirements needed to ensure optimization are met. As defined herein, a “penalty” is a mathematical device (which may encompass any number of variables) for optimizing a blending plan for an NFC consumable product. For example, a penalty may be assessed for using a stored fruit juice during a harvesting season (i.e., “in-season”) when fresh fruit juice is readily available, a penalty may be assessed for overproduction (thereby violating demand requirements for various component juices utilized in blending), and a penalty may be assessed based on the flow of a juice component (i.e., a fruit juice mixed with other fruit juices to produce a blended NFC fruit juice) from either a tank storage or a supplier to a blending plant during a blending time interval. It should be understood that similar penalties may be assessed for NFC consumable products other than fruit juices without departing from the spirit and scope of the various embodiments described herein.

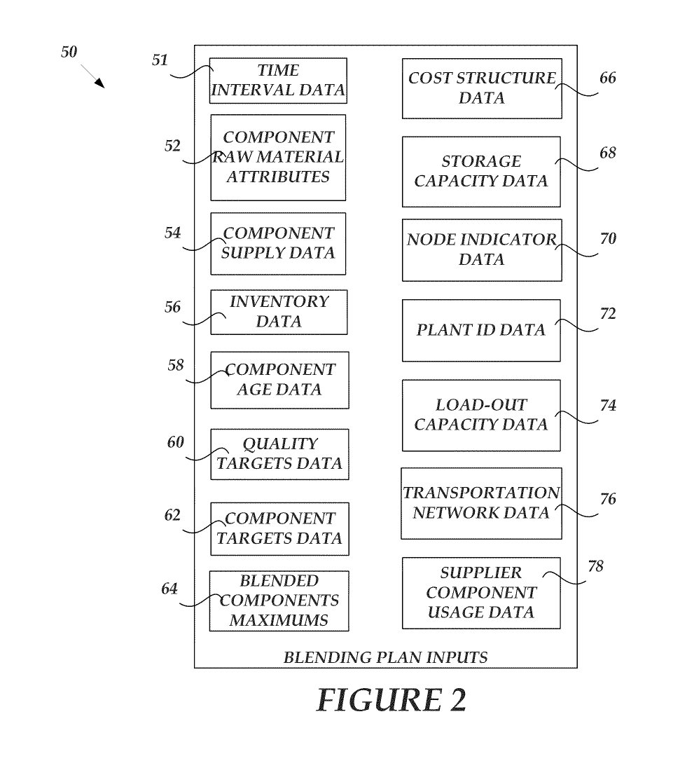

FIG. 2 is a block diagram illustrating various inputs in the blending plan inputs 50 which may be utilized in optimizing a blending plan for NFC consumable products, in accordance with various embodiments. The blending plan inputs 50 may include time interval data 51, component raw material attributes 52, component supply data 54, inventory data 56, component age data 58, quality targets data 60, component targets data 62, blended component targets 64, cost structure data 66, storage capacity data 68, node indicator data 70, plant ID data 72, load-out capacity data 74, transportation network data 76 and supplier component usage data 78.

The time interval data 51 may include a blending plan time interval for an NFC consumable product. The blending plan time interval may comprise various units of time with the smallest interval consisting of one week. Thus, each blending plan time interval may be a weekly time interval. In accordance with an embodiment, the optimized blending plan may consist of a rolling sixty-five week blend plan. It should be understood that in accordance with the embodiments described herein, annual, six week and weekly blend plans may be produced. It should further be understood that the results of the blending plan optimization discussed herein may be aggregated into weekly, monthly and quarterly totals to support research and development, procurement and supply chain activities.

The component raw material attributes 52 may include various attribute specifications for an NFC consumable product. For example, the attribute specifications for an NFC juice product may include, without limitation, Brix (i.e., the sugar content of an aqueous solution), citric acid, Brix acid ratio, centrifuge pulp, Vitamin C, percent recovered oil, color score, defects score, limonin, flavor and varietal percentages (e.g., the percentages of various fruit juice varieties making up a finished NFC juice product). It should be appreciated by those skilled in the art that other attribute specifications corresponding to the production of different types of NFC consumable products (e.g., liquid food and dairy products) may also be utilized without departing from the spirit and scope of the various embodiments described herein.

The component supply data 54 may include one or more suppliers which are contracted to supply the various components utilized in blending an NFC consumable product over the blending plan time interval. For example, the components (e.g., fruit) utilized in blending an NFC fruit (e.g., orange) juice may consist of a projected number of gallons per month for each of multiple fruit juices provided by various suppliers located in different geographical locations.

The inventory data 56 may include an initial inventory of storage components (e.g., gallons of a stored liquid) utilized in blending an NFC consumable product per storage tank.

The component age data 58 may include a stored age of one or more components utilized in blending an NFC consumable product. It should be understood, in accordance with generating an optimized blending plan in accordance with the embodiments described herein, that the storage of a component utilized in an NFC consumable product may not exceed a maximum storage time (e.g., sixty-five weeks).

The quality targets data 60 may include finished goods quality targets for NFC consumable products. For example, with respect to an fruit juice, finished goods quality targets may include Brix targets, Brix acid ratio targets, centrifuge pulp percent targets, Vitamin C targets, percent recovered oil targets, a color score targets, a defects score minimum, flavor targets and limonin targets. It should be appreciated by those skilled in the art that other finished goods quality targets corresponding to the production of different types of NFC consumable products (e.g., liquid food and dairy products) may also be utilized without departing from the spirit and scope of the various embodiments described herein.

The component targets data 62 may include finished goods component targets for NFC consumable products. For example, with respect to an orange juice, finished goods component targets may include target percentages for different varieties of orange juice utilized in blending an NFC orange juice product. Continuing with the aforementioned example, the finished goods and component targets may also include percentages of fresh juice with respect to each of one or more varieties of orange juice utilized in blending the NFC orange juice product. It should be appreciated by those skilled in the art that other finished goods component targets corresponding to the production of different types of NFC consumable products (e.g., liquid food and dairy products) may also be utilized without departing from the spirit and scope of the various embodiments described herein

The blended components maximums 64 may include data identifying a maximum number of blended components at a blending facility utilized for blending an NFC consumable product. For example, the data may include data for various stored components in various tank farms as well as fresh and stored components from various suppliers.

The cost structure data 66 may include various costs associated with the production of a blended NFC consumable product from various components. For example, the costs may include solid costs (e.g., dollars per gallon) associated with obtaining each of a number of different components (e.g., dollars per gallon) from suppliers, processing costs (e.g., dollars per gallon) associated with processing each of a number of different components from suppliers, storage costs (e.g., dollars per gallon) associated with storing components at various tank farms, transportation costs (e.g., dollars per gallon) associated with transporting components from a source (e.g., a supplier) to a plant for blending and production costs associated with blending the NFC consumable product at each of one or more plants utilized for blending.

The storage capacity data 68 may include data associated with contracted and to be purchases storage capacity at one or more tank farms utilized to store various components which are utilized in the production of a blended NFC consumable product. For example, storage capacity data may include various tank farm IDs as well as the names and locations of the tank farms.

The node indicator data 70 may include data for determining the application of business rules such as when a refill of available storage capacity is needed for contracted and/or to be purchased components which are utilized in the production of a blended NFC consumable product.

The plant ID data 72 may include plant IDs for the names of various blending plants utilized in producing a blended NFC consumable product.

The load-out capacity data 74 may include various capacities associated with the loading of components utilized in the production of a blended NFC consumable product, between one or more of a tank farm and a plant, a processor and a plant, a port and a tank farm, and a port and a plant. For example, the load-out capacity for a stored or fresh component (e.g., fresh fruit juice) may be determined by the expression: gallons/weeks=truck loads.

The transportation network data 76 may include routing information for transporting various components utilized in the production of a blended NFC consumable product, between a port and one or more tank farms, a processor and one or more tank farms, and one more tank farms and blending plants. For example, there may be two transportation routes between a port and tank farms, four routes between a processor and tank farms and twenty-five routes between tank farms and blending plants.

The supplier component usage data 78 may include a total quantity of one or more components (e.g., juice) utilized in the production of a blended NFC consumable product, used from a supplier. It should be understood that there may be a minimum component usage requirement (i.e., in gallons) associated with each supplier.

It should be understood that the blending plan inputs 50 may be utilized in a number of production scenarios in the blending of an NFC consumable product. In particular, an NFC consumable product may be made from various combinations (and various amounts) of components to achieve a desired product.

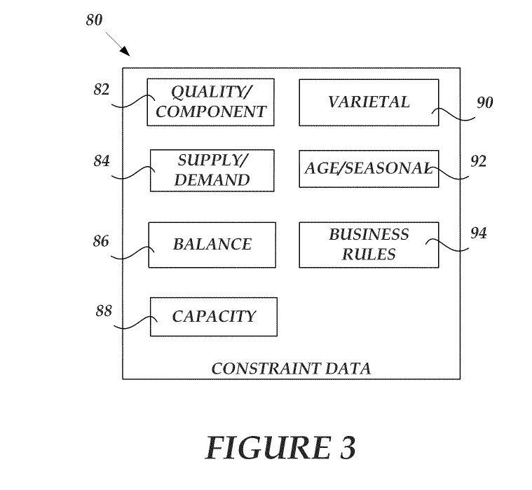

FIG. 3 is a block diagram illustrating constraint data 80 utilized in optimizing a blending plan for NFC consumable products, in accordance with various embodiments. The constraint data 80 may include quality/component constraints 82, supply/demand constraints 84, balance constraints 86, capacity constraints 88, varietal constraints 90, age/seasonal constraints 92, and business rules constraints 94.

The quality/component constraints 82 may include quality targets (i.e., a quality range) component targets for an NFC consumable product in order to enforce finished product and component quality over a blending plan time interval. For example, quality targets may be enforced for the following raw material attributes for an NFC fruit juice (i.e., the finished product): Brix, acid-Brix ratio, color, Vitamin C, pulp and limonin. As a further example, targets may be enforced for various stored and fresh fruit juices utilized in the blending of an NFC fruit juice (i.e., the finished product).

The supply/demand constraints 84 may include minimum and maximum requirements (for each of one or more suppliers) for various components which are utilized in the production of an NFC consumable product. For example, a sourcing requirement for a fruit juice may consist of the sum of fresh juice in production and fresh juice sent to storage is less than or equal to a total juice supply. A minimum supply requirement for a fruit juice may consist of the sum of fresh juice in production and fresh juice sent to storage being greater than or equal to a minimum juice supply. A minimum usage requirement for a fruit juice may consist of fresh juice in production being greater than or equal to a minimum usage of a fruit juice. A minimum requirement for a fruit juice for a supplier (e.g., supplier produced juice and tank farm stored juice from purchases) may consist of fresh juice in production being greater than or equal to a minimum fruit juice requirement. A demand requirement for a fruit juice may consist of the sum of fresh fruit in production and stored juice in production being greater than or equal to a fruit juice demand. A minimum carry-over requirement (i.e., for each tank farm) for a fruit juice may consist of a fruit juice variety in the carry over juice being greater than a minimum inventory requirement.

The balance constraint 86 may include a requirement for enforcing component conservation for components utilized in the production of an NFC consumable product. For example, a component conservation requirement for a tank balance for a fruit juice may consist of a sum of juice carried over from a previous time period and newly stored juice in the tank being equal to a sum of juice carried over into the next time period and juice sent from a processing plant to the tank. Another example of a component conservation requirement for a tank balance for a fruit juice may consist of stored juice in a refillable tank (at each of one or more time periods) being equal to a sum of stored juice in the tank at a next time period and juice sent to a processing plan from the tank during the next time period. An example of a component conservation requirement for a tank farm balance for a fruit juice may consist of a sum of fresh juice carried over from a previous time period into a tank farm and newly stored juice in a tank farm being equal to a sum of juice carried over into a next time period from the tank farm and juice sent to a processing plant from the tank farm.

The capacity constraints 88 may include a requirement for enforcing capacity limitations on a flow of various components utilized in the blending of an NFC consumable product. Example capacity limitations may include making sure that a newly stored component and/or any carried over components (i.e., carried over from a previous time interval) is less than or equal to a tank capacity for a predetermined time period, a newly stored component in a tank farm and a component carried over from a previous time interval is less than or equal to a tank farm capacity, a newly stored juice in a tank farm is less than or equal to a pasteurization capacity in the time interval, and juice from each of a supplier/plant and tank farm/plant combination over a time interval being less than or equal to a load out capacity.

The varietal constraints 90 may include a requirement for enforcing varietal percentages for components in a blended NFC consumable product. Example varietal constraints may include percentages of a component in an NFC blended product going to a processing plant being greater than equal to a minimum requirement and less than or equal to a maximum requirement.

The age/seasonal constraints 92 may include a requirement for enforcing varietal percentages for components in a blended NFC consumable product using fresh (instead of stored) components. For example, for a fruit juice, the requirement may include a maximum age allowance for a fresh juice (i.e., juice stored in a storage tank may not exceed the maximum age allowance), a restriction against the use of stored juice from a tank when fresh juice is in-season, and a restriction against storing fresh juice in a tank.

The business rules constraints 94 may include various requirements such as restricting the flow of components from predetermined tank farms or suppliers to predetermined blending plants.

### Exemplary Operating Environment

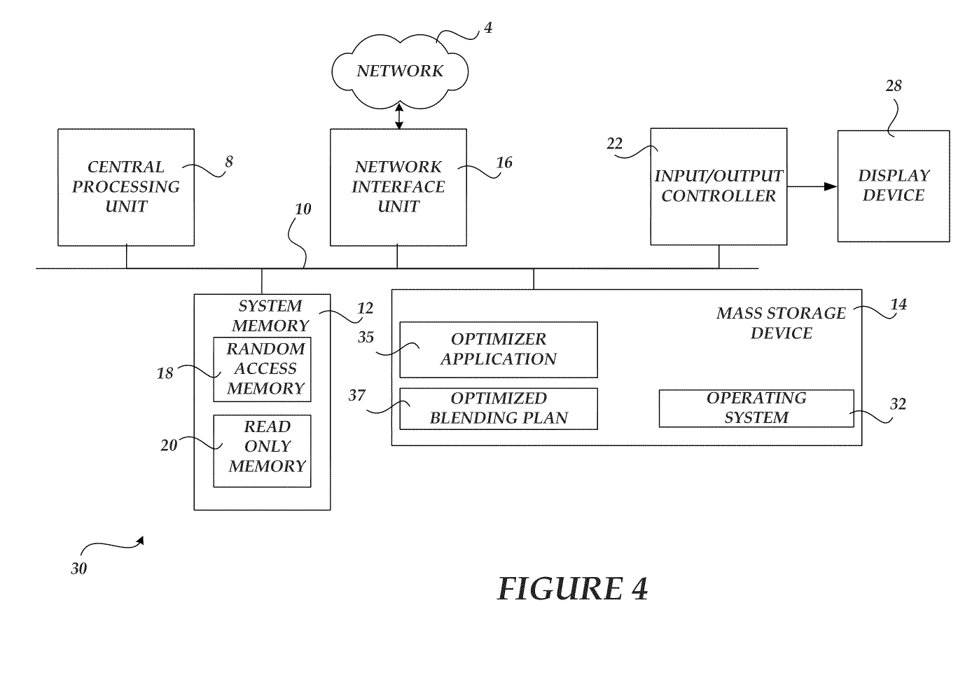

Referring now to FIG. 4, the following discussion is intended to provide a brief, general description of a suitable computing environment in which various illustrative embodiments may be implemented. While various embodiments will be described in the general context of program modules that execute in conjunction with program modules that run on an operating system on a computing device, those skilled in the art will recognize that the various embodiments may also be implemented in combination with other types of computer systems and program modules.

Generally, program modules include routines, programs, components, data structures, and other types of structures that perform particular tasks or implement particular abstract data types. Moreover, those skilled in the art will appreciate that the various embodiments may be practiced with a number of computer system configurations, including hand-held devices, multiprocessor systems, microprocessor-based or programmable consumer electronics, minicomputers, mainframe computers, and the like. The various embodiments may also be practiced in distributed computing environments where tasks are performed by remote processing devices that are linked through a communications network. In a distributed computing environment, program modules may be located in both local and remote memory storage devices.

FIG. 4 shows the server 30 which may comprise a computing device which 2 includes at least one central processing unit 8 (“CPU”), a system memory 12 (including a random access memory 18 (“RAM”) and a read-only memory (“ROM”) 20) and a system bus 10 that couples the memory to the CPU 8. A basic input/output system containing the basic routines that help to transfer information between elements within the computer, such as during startup, is stored in the ROM 20. The server 30 further includes a mass storage device 14 for storing an operating system 32, the optimizer application 35 and an optimized blending plan 37, which is generated by the optimizer application 35.

In accordance with various embodiments, the operating system 32 may be suitable for controlling the operation of a networked computer. The mass storage device 14 is connected to the CPU 8 through a mass storage controller (not shown) connected to the bus 10. The mass storage device 14 and its associated computer-readable media provide non-volatile storage for the computing device 2. The term computer-readable media as used herein may include computer storage media. Computer storage media may include volatile and nonvolatile, removable and non-removable media implemented in any method or technology for storage of information, such as computer readable instructions, data structures, program modules, or other data. Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by the computing device 2. Any such computer storage media may be part of the computing device 2.

The term computer-readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

According to various embodiments, the server 30 may operate in a networked environment using logical connections to remote computers through a network 4 which may include a local network or a wide area network (e.g., the Internet). The server 30 may connect to the network 4 through a network interface unit 16 connected to the bus 10. It should be appreciated that the network interface unit 16 may also be utilized to connect to other types of networks and remote computing systems. The server 30 may also include the input/output controller 22 for receiving and processing input from a number of input types, including, but not limited to, a keyboard, mouse, pen, stylus, finger, and/or other means (not shown). Similarly, an input/output controller 22 may provide output to a display device 28 as well as a printer, or other type of output device (not shown).

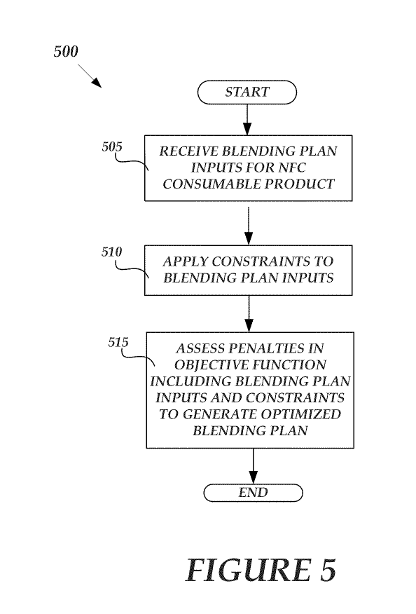

FIG. 5 is a flow diagram 500 illustrating a routine for optimizing a blending plan for NFC consumable products, in accordance with various embodiments. When reading the discussion of the routines presented herein, it should be appreciated that the logical operations of various embodiments of the present invention are implemented (1) as a sequence of computer implemented acts or program modules running on a computing system and/or (2) as interconnected machine logical circuits or circuit modules within the computing system. The implementation is a matter of choice dependent on the performance requirements of the computing system implementing the invention. Accordingly, the logical operations illustrated in FIG. 5 and making up the various embodiments described herein are referred to variously as operations, structural devices, acts or modules. It will be recognized by one skilled in the art that these operations, structural devices, acts and modules may be implemented in software, in firmware, in special purpose digital logical, and any combination thereof without deviating from the spirit and scope of the present invention as recited within the claims set forth herein.

The routine 500 begins at operation 505, where the optimizer application 35, executing on the application server 30, receives the blending plan input data 50 for an NFC consumable product. As discussed above with respect to FIG. 2, the blending plan input data 50 may comprise various inputs associated with a blending plan for the production of a consumable product over a predetermined time interval.

From operation 505, the routine 500 continues to operation 510, where the optimizer application 35 executing on the application server 30, may apply the constraint data 80 to the received blending plan input data 50. In particular, in applying the various constraints in the constraint data 80, the optimizer application 35 may utilize a mathematical model (i.e., a model formulation) to generate an optimized blending plan which minimizes costs and complexity associated with the production of an NFC consumable product while maximizing quality. In accordance with an embodiment, the model formulation may comprise an objective function against which is applied several constraints. It should be understood that the optimizer application 35 may also utilize the aforementioned objective function to generate an optimized blending plan which minimizes deviation quality targets and the violation of business rules, associated with the production of an NFC consumable product. For example, in accordance with an embodiment, the objection function may be utilized to minimize processing costs (i.e., per unit processing fees for raw materials from a supplier at a time interval), solid costs (i.e., per unit costs for raw materials from a supplier at a time interval), transportation costs (i.e., per unit transportation costs from a supplier to a blender) and storage costs associated with the production of a blended NFC consumable product.

From operation 510, the routine 500 continues to operation 515, where the optimizer application 35 executing on the application server 30, may assess penalties in an objective function (discussed above) which includes the blending plan input data 50 and the constraint data 80, to generate an optimized blending plan for an NFC consumable product. In particular, and as discussed above with respect to FIG. 1, it should be understood that in generating the optimized blending plan 37, the optimizer application 35 may utilize the aforementioned model formulation to assess various penalties to ensure that various requirements needed to ensure optimization objectives are met for producing blended NFC consumable products. For example, a penalty may be assessed for using a stored component during a harvesting season (i.e., “in-season”) when a fresh component (e.g., fresh fruit juice) is readily available, a penalty may be assessed for overproduction (thereby violating demand requirements for various component juices utilized in blending), a penalty may be assessed based on the flow of a component (i.e., a liquid mixed with other liquids to produce a blended NFC consumable product) from either a tank storage or a supplier to a blending plant during a blending time interval, and a penalty may be assessed for violating end supply and demand requirements associated with an optimized blended NFC consumable product. It should be further understood that the optimizer application 35 may also be utilized to optimize NFC consumable product quality by minimizing deviations from target attributes (e.g., flavor) for a concentrated consumable product over a time interval. It should be understood that the objective function may optimize positive and negative deviations for an attribute from a target quality objective at a plant over a period of time.

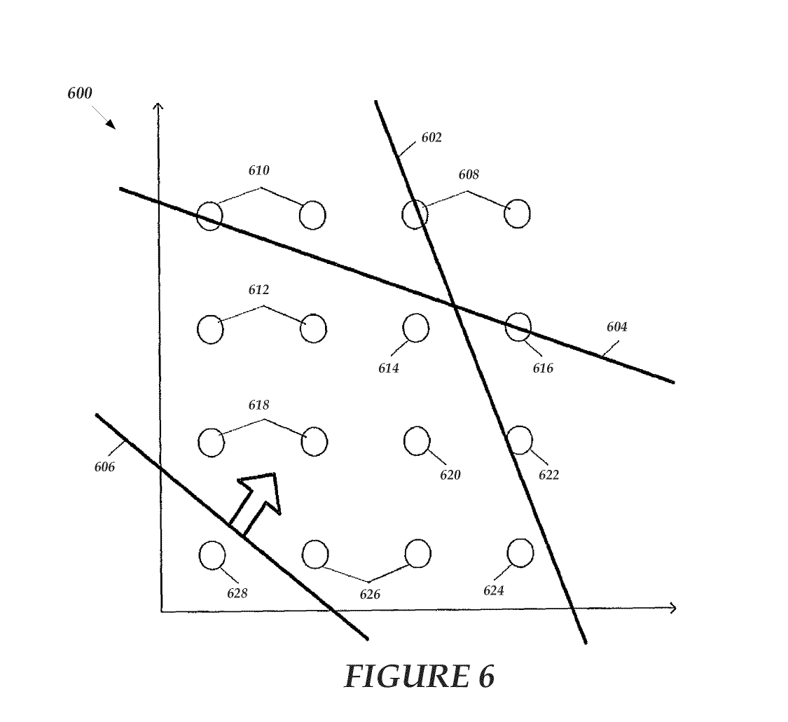

FIG. 6 is a graphical representation 600 of an objective function and constraints utilized by a model formulation to optimize a blending plan for NFC consumable products, in accordance with an embodiment. In the graphical representation 600, lines 602, 604 and 606 comprise constraints (e.g. requirements) and circles 608, 610, 612, 614, 616, 618, 620, 622, 624, 626 and 628 comprise possible solutions to the objective function in the above-described model formulation. In the model formulation, the objective function is maximized by finding a solution (i.e., a circle) that is inside of all of the constraints 602, 604 and 606 (i.e., a solution which obeys each of the constraints). Circles that are within the constraints 602, 604 and 606 are feasible solutions while circles outside of the constraints 602, 604 and 606 are infeasible. Thus, it may be seen with respect to the blending plan 600 that the circle (i.e., solution) 614 is optimal since it lies within each of the constraints 602, 604 and 606 and is the point that maximizes the objective function. Those skilled in the art should appreciate that the use of the penalties, discussed, is also referred to as multi-criteria optimization. It should further be appreciated that the aforementioned penalties may be user-configurable values which may be determined via experimentation by a decision-maker involved in creating an NFC consumable product blending plan.

The notation and equations for an illustrative optimization model formulation which optimizes a blending plan for NFC consumable products is shown below. It should be understood that the foregoing notation and equations may be applied to any number of NFC consumable products including, but not limited, of fruit juices (e.g., orange juice, apple juice, etc.), liquid dairy products (e.g., milk, etc.) and liquid food products (e.g., yogurt, soup, etc.).

### Notation:

### Indices

w: time interval
sw: supply time interval for stored raw material
ww1: carried inventory time interval ww1 = w − 1
s: supplier ID
sy: supplier type; sy ∈{P₁, P_{2,} P₃} where
P₁, P_{2,} P₃ are different supplier types
j: raw material ID (a batch of raw material with
specific attributes and category composition)
jy: raw material types;
v: raw material category ID;
c: raw material contract type;
t: facility ID
f: storage unit ID

### Sets/Tuples

W: time intervals set
S: set of suppliers
F: set of facilities
T: set of storage units
V: set of raw material categories
J: set of raw materials
C: set of raw material contract types
SY: set of possible supplier-raw material types
SW: start time intervals set for stored raw material
WW: first N periods set (where N can be any number)
WM: periods set
SPW: set of possible load-outs from source s to plant
p in time interval w
FPVW: set of possible load-outs of raw material
category v from farm f to plant p in time interval w
ZPW: set of possible load-outs from port z to plant p
in time interval w
SYVJwCYW: set of possible supply-raw material links
(S-SType-V-J-SW-C-JType-W)
SYFVJwCYT: supply-raw material-tank links within farm
(S-SType-V-J-SW-C-JType-T)
SYFVJwCYTW: set of possible supplier-material-tank
links (S-SType-F-V-J-SW-C-JType-T-W)
VJwCYT: set of possible stored varietal-juice-tank
links (V-J-SW-C-JType-T)

### Parameters

NW: number of time intervals
NW_{w}: number of periods in a time interval
NWCat_{w}: number of periods in a time interval
for a specific raw material category
LQ_{q}, UQ_{q}: lower and upper bounds for attribute q
MaxJAge: Upper bound on the stored raw material age
littleS: Penalty for using stored raw material in season
littleM: penalty for violating the End Supply and Demand
Constraints
ProdPenalty: penalty for over production
FlowPenalty: penalty for flows
TankPenalty: orphan tank penalty
TankOpenPenalty: tank open penalty

### Seasonality and Component Targets

| | |
|---|---|
| CatSeason_{vw}: | Indicator for penalized seasons for Category v |
| ISRefillₜ: | Node indicator for refillable storage unit |
| JSeason_{jw}: | Indicator for season raw material |
| MinAttr_{vw}: | Minimum percentage of category v in time |
| | interval w for finished products |
| MaxAttr_{vw}: | Maximum percentage of varietal v in time |
| | interval w for finished products |
| MinF_{vw}: | Minimum percentage of fresh varietal v in time |
| | interval w for finished products |
| Target_{qpw} | Target for attribute q at plant p in period w |
| W_{q} | Weight for attribute q |

### Attributes

| | |
|---|---|
| Q_{qj}: | Attribute content of attribute q in raw material j |

### Costs

| | |
|---|---|
| SolidCostsjw[<s,sy,v,j,sw,c,jy,w> ∈ SYVJwCYW]: | Per gallon solid cost for raw material j of from |
| | supplier s at time interval w |
| ProcessingCostsjw [<s,sy,v,j,sw,c,jy,w> ∈ | Per gallon processing cost for raw material j |
| SYVJwCYW]: | from supplier s at time interval w |
| St_SolidCostsj[<v,j,sw,c,jy,t> ∈ VJwCYT]: | Per gallon solid cost for stored raw material j |
| | of storage unit t |
| St_ProcessingCostsj [<v,j,sw,c,jy,t> ∈ VJwCYT]: | Per gallon processing cost for stored raw |
| | material j of storage unit t |
| StorageCostt[t ∈ T]: | Per gallon storage cost at storage unit t |
| TransportationCostspw[<s,p,w> ∈ SPW]: | Per gallon transportation cost from supplier s |
| | at plant p at time interval w |
| TransportationCostfpw[<f,p,w> ∈ FPW]: | Per gallon transportation cost from farm f at |
| | plant p at time interval w |

### Capacity

| | |
|---|---|
| TkCap_{t:} | Storage capacity at storage unit t |
| FCap_{f}: | Storage capacity at facility f |
| PCap_{fw}: | Processing capacity at facility fin time |
| | interval w |
| Uf_{pw}: | Load-out capacity from facility f to blend plant |
| | p at time interval w (stored components) |
| Us_{pw}: | Load-out capacity from supplier s to blend |
| | plant p at time interval w (fresh components) |
| Demand_{pw}: | Demand forecast for plant p at time interval w |
| Supply_{sw}: | Available raw material from source s at time |
| | interval w |
| MinSₛ: | Minimum amount of raw material to be source |
| | from supply s |
| MinUsageₛ: | Minimum amount of raw material go directly |
| | to the plant from supply s |
| MinReq_{vf}: | Minimum amount of to be purchased stored |
| | raw material from facility f of category v |
| MinCO_{fpvw}: | Minimum carry-over for category v from |
| | facility f to plant p in the time interval w |
| Nₚ: | Maximum number of components that can be |
| | blended at plant p |
| N_{f}: | Maximum number of stored components that |
| | can be blended at facility f |
| ISvjswt[<v,j,sw,c,jy,t> ∈ | Initial inventory of raw material j of category v |
| VJwCYT]: | in storage unit t at time interval sw |
| ESᵥ: | Ending supply requirement for category v |
| TSTARTₜ: | The first period that category t is available |
| TENDₜ: | The last period that tank t is available |

### Decision Variables

| | |
|---|---|
| Xsfjtw[<s,sy,f,v,j,sw,c,jy,t,w> ∈ SYFVJwCYTW]: | Supplier to storage unit flow = amount of raw |
| | material j from supplier s to storage unit t of |
| | facility f in time interval w |
| Xftjww1[<s,sy,f,v,j,sw,c,jy,t> ∈ SYFVJwCYT,ww1 | Storage unit carried inventory = amount of |
| 0 . . . NW]: | carried raw material j in storage t at facility f |
| | from time interval w |
| Xsfjtw[<s,sy,f,v,j,sw,c,jy,t,w> ∈ SYFVJwCYTW]: | Supplier to storage unit flow = amount of raw |
| | material j from supplier s to storage unit t of |
| | facility f in time interval w |
| X_{ftjww1}[<s,sy,f,v,j,sw,c,jy,t> ∈ SYFVJwCYT,ww1 | Storage unit carried inventory = amount of |
| 0 . . . NW]: | carried raw material j in storage unit t at facility |
| | f from time interval w |
| DevP_{qpw} | Positive Deviation from Target for quality q at |
| | plant p in period w |
| DevN_{qpw} | Negative Deviation from Target for quality q at |
| | plant p in period w |

### Objective Function

### Cost Objective

$$Min {\sum }_{t , j , p , w}^{ } {X}_{tjpw} * ( {St\_ ProcessingCost}_{tj} + {St\_ SolidCost}_{tj} ) + {\sum }_{s , j , p , w}^{ } {X}_{sjpw} * ( {ProcessingCost}_{sjw} + {SolidCost}_{sjw} ) + {\sum }_{s , f , j , t , w}^{ } {X}_{sfjtw} * ( {ProcessingCost}_{sjw} + {SolidCost}_{sjw} ) + {\sum }_{f , t , j , p , w}^{ } {X}_{tjpw} * {TransportationCost}_{fpw} + {\sum }_{s , sy = P , p , w}^{ } {X}_{sjpw} * {TransportationCost}_{spw} + {\sum }_{s , sy = Z , p , w}^{ } {X}_{tjpw} * {TransportationCost}_{zpw} + {\sum }_{f , t , j , p , w , sy = z}^{ } {X}_{tjpw} * {TransportationCost}_{zfw} + {\sum }_{f , t , j , p , w}^{ } {X}_{tjpw} * {StorageCost}_{t} + ( {\sum }_{t , j , p , w}^{ } {X}_{tjpw} + {\sum }_{s , j , p , w}^{ } {X}_{sjpw} - {\sum }_{p , w}^{ } {Demand}_{pw} ) * ProdPenalty + {\sum }_{f , t , v , j , p , w}^{ } {X}_{tjpw} * littleS * {CatSeason}_{c , w} + ( {\sum }_{t , j , p , w}^{ } {X}_{tjpw} + {\sum }_{s , j , p , w}^{ } {X}_{sjpw} + {\sum }_{s , f , j , t , w}^{ } {X}_{sfjtw} ) * FlowPenalty$$

Quality Objective: Maximizing Quality by Minimizing the Deviation from Quality Targets

$$Min {\sum }_{q , p , w}^{ } ( {DevP}_{qpw} + {DevN}_{qpw} ) * {W}_{q}$$

### Constraints

### Attribute Constraints

$${LQ}_{q} * ( {\sum }_{f , t , j , p , w}^{ } {X}_{tjpw} + {\sum }_{s , j , p , w}^{ } {X}_{sjpw} ) \leq {\sum }_{f , t , j , p , w}^{ } {Q}_{q , j} {X}_{tjpw} + {\sum }_{s , j , p , w}^{ } {Q}_{q , j} {X}_{sjpw} \leq {UQ}_{q} * ( {\sum }_{f , t , j , p , w}^{ } {X}_{f , t , j , p , w} + {\sum }_{s , j , p , w}^{ } {X}_{sjpw} ) ∀ p , w$$

### Maximize Quality Only

$${\sum }_{f , t , j , p , w}^{ } {Q}_{q , j} {X}_{tjpw} + {\sum }_{s , j , p , w}^{ } {Q}_{q , j} {X}_{sjpw} + {DevP}_{q , p , w} - {DevN}_{q , p , w} = {Target}_{q , p , w} ∀ q , p , w$$

### Varietal Components Targets

$${MinAttr}_{vw} * ( {\sum }_{f , t , j , p , w}^{ } {X}_{tjpw} + {\sum }_{s , j , p , w}^{ } {X}_{sjpw} ) \leq {\sum }_{f , t , j , p , w}^{ } {Pct}_{vj} {X}_{tjpw} + {\sum }_{s , j , p , w}^{ } {Pct}_{vj} {X}_{sjpw} ; ∀ p , w$$

$${MaxAttr}_{vw} * ( {\sum }_{f , t , j , p , w}^{ } {X}_{tjpw} + {\sum }_{s , j , p , w}^{ } {X}_{sjpw} ) \geq {\sum }_{f , t , j , p , w}^{ } {Pct}_{vj} {X}_{tjpw} + {\sum }_{s , j , p , w}^{ } {Pct}_{vj} {X}_{sjpw} ; ∀ p , w$$

### Fresh Components Constraints

$${\sum }_{s , sy = P , v , j , p , w}^{ } {X}_{sjpw} - {MinF}_{vw} * ( {\sum }_{f , t , j , p , w}^{ } {X}_{tjpw} + {\sum }_{s , j , p , w}^{ } {X}_{sjpw} ) \geq 0 , ∀ p , w$$

$${\sum }_{s , sy = P , v , j , p , w}^{ } {X}_{sjpw} - {MaxF}_{vw} * ( {\sum }_{f , t , j , p , w}^{ } {X}_{tjpw} + {\sum }_{s , j , p , w}^{ } {X}_{sjpw} ) \leq 0 , ∀ p , w$$

### Raw Material Age Constraints

$${\sum }_{f , t , j , ww 1}^{ } {X}_{ftjww 1} \leq 0 ;$$

$${IS}_{vjswt} \geq 0 , \\ JAge {0}_{j} + {\sum }_{w}^{ } {NW}_{w} - 1 \geq MaxJage$$

### Supply-Demand Constraints

### Sourcing Constraints

$${\sum }_{s , j , p , w}^{ } {X}_{sjpw} + {\sum }_{s , f , j , t , w}^{ } {X}_{sfjtw} \leq {Supply}_{sw} ;$$

$$∀ s , w$$

### Minimum Requirement Constraints

$${\sum }_{s , j , p , w}^{ } {X}_{sjpw} + {\sum }_{s , f , j , t , w}^{ } {X}_{sfjtw} \geq {MinS}_{s} ;$$

$$∀ s$$

### Minimum Usage Constraints

$${\sum }_{s , j , p , w}^{ } {X}_{sjpw} \geq {MinUsage}_{s} ;$$

$$∀ s$$

Facility Stored Raw Material from Purchase Minimum Requirements Constraints

$${\sum }_{t , jy = S , c = A , v , p , w}^{ } {X}_{tjpw} \geq {MinReq}_{v , f} ;$$

$$∀ f , v ∈ ( EM , VAL )$$

### Demand Constraints

$${\sum }_{s , j , p , w}^{ } {X}_{sjpw} + {\sum }_{s , f , j , t , w}^{ } {X}_{sfjtw} \geq {Demand}_{pw} ;$$

$$∀ p , w$$

### Minimum Carry-Over Constraints

$$( {\sum }_{f , t , j , ww 1}^{ } {X}_{ftjww 1} ) * {Pct}_{vj} \geq {MinCO}_{fpvw} * \frac{{Demand}_{pw + 1}}{{NWw}_{w + 1}} * 2 ;$$

$$∀ w = 1 … NM - 1$$

### Balance Constraints

### Storage Unit Balance Constraints

$${\sum }_{f , t , j , ww 1}^{ } {X}_{ftjww 1} + {\sum }_{{s , f , j , t , w}_{∈ SYFVJwCYT , w}}^{ } {X}_{sfjtw} = {X}_{ftjww 1} + {\sum }_{f , t , j , p , w}^{ } {X}_{tjpw} ;$$

$$∀ [ 〈 sy , f , v , j , w , c , jy , t 〉 ]$$

### Capacity Constraints

### Storage Unit Capacity Constraints (Out Months)

$${\sum }_{t , j , ww 1}^{ } {X}_{ftjww 1} \leq {TkCap}_{t} ;$$

$$∀ w ∈ WM , t$$

Facility Capacity Constraints (out months)

$${\sum }_{f , t , j , ww 1}^{ } {X}_{ftjww 1} + {\sum }_{s , f , j , t , w}^{ } {X}_{sfjtw} \leq {FCap}_{f} * {NW}_{w} ;$$

$$∀ w ∈ WM , f , {ISRefill}_{t} = 1$$

### Load-Out Capacity Constraints (Supplier to Plant)

$${\sum }_{s , j , p , w}^{ } {X}_{sjpw} \leq {U}_{spw} ;$$

$$∀ s = P , p , w$$

### Load-Out Capacity Constraints (Supplier to Plant)

$${\sum }_{s , j , p , w}^{ } {X}_{sjpw} \leq {U}_{spw} ;$$

$$∀ s = Z , p , w$$

### Load-Out Capacity Constraints (Farm to Plant)

$${\sum }_{f , t , j , p , w}^{ } {X}_{tjpw} \leq {U}_{fpw} ;$$

$$∀ f , p , w$$

### Load-Out Capacity Constraints (Port to Farm)

$${\sum }_{f , t , j , p , w}^{ } {X}_{tjpw} \leq {U}_{sfw} ;$$

$$∀ s = Z , f , w$$

### Processing Capacity Constraints

$${\sum }_{s , f , j , t , w}^{ } {X}_{sfjtw} \leq {NW}_{w} * {PCap}_{fw} ;$$

$$∀ f , w , {ISRefill}_{t} = 1$$

$${\sum }_{s , f , j , t , w , v = V}^{ } {X}_{sfjtw} \leq {NWVAL}_{w} * {PCap}_{fw} ;$$

$$∀ f , w , {ISRefill}_{t} = 1$$

$${\sum }_{s , f , j , t , w , v = E}^{ } {X}_{sfjtw} \leq {NWEM}_{w} * {PCap}_{fw} ;$$

$$∀ f , w , {ISRefill}_{t} = 1$$

### Business Rule Constraints

### Prohibited Component

$$( {\sum }_{s , j , p , w}^{ } {X}_{sjpw} + {\sum }_{s , j , t , w}^{ } {X}_{sjtw} ) * {Pct}_{vj} \leq 0 ;$$

$$∀ w , v = {V}_{1}$$

Fresh Raw Material in-Season

$${\sum }_{t , j , p , w}^{ } {X}_{tjpw} \leq 0 ;$$

$$∀ w \text{:} CatSeason [ w ] > 0 , \\ v ∈ \{ {V}_{1} , {V}_{2} \}$$

### Prohibited Supply Chain Link

$${\sum }_{t , j , p , w , f = {F}_{1} , p = {P}_{1}}^{ } {X}_{tjpw} \leq 0$$

Various embodiments are described above with reference to block diagrams and/or operational illustrations of methods, systems, and computer program products. The operations/acts noted in the blocks may be skipped or occur out of the order as shown in any flow diagram. For example, two blocks shown in succession may in fact be executed substantially concurrently or the blocks may sometimes be executed in the reverse order, depending upon the functionality/acts involved.

While certain embodiments have been described, other embodiments may exist. Furthermore, although various embodiments have been described as being associated with data stored in memory and other storage mediums, data can also be stored on or read from other types of computer-readable media, such as secondary storage devices (i.e., hard disks, floppy disks, or a CD-ROM), a carrier wave from the Internet, or other forms of RAM or ROM. Further, the disclosed routine's operations may be modified in any manner, including by reordering operations and/or inserting or operations, without departing from the embodiments described herein.

Although the invention has been described in connection with various illustrative embodiments, those of ordinary skill in the art will understand that many modifications can be made thereto within the scope of the claims that follow. Accordingly, it is not intended that the scope of the invention in any way be limited by the above description, but instead be determined entirely by reference to the claims that follow.

What is claimed is:

1. A computer-implemented method of optimizing a blending plan for not-from-concentrate (NFC) consumable products, comprising:
receiving one or more inputs associated with a blending plan for the production of a consumable product over a predetermined time interval;
applying, by the computer, one or more constraints to each of the one or more inputs; and
assessing, by the computer, one or more penalties in a function comprising the one or more inputs and the one or more constraints, the function utilizing the one or more constraints and the one or more penalties to generate an optimized blending plan which minimizes costs and complexity associated with the production of the consumable product while maximizing quality.

2. The method of claim 1, wherein receiving one or more inputs associated with a blending plan for the production of a consumable product over a predetermined time interval comprises receiving the one or more inputs over one or more weekly time intervals.

3. The method of claim 1, wherein receiving one or more inputs associated with a blending plan for the production of a consumable product over a predetermined time interval comprises receiving one or more raw material attributes for components utilized in producing the consumable product.

4. The method of claim 1, wherein receiving one or more inputs associated with a blending plan for the production of a consumable product over a predetermined time interval comprises receiving supply data comprising quantities of various components provided by one or more suppliers, the components being utilized in the blending of the consumable product.

5. The method of claim 1, wherein receiving one or more inputs associated with a blending plan for the production of a consumable product over a predetermined time interval comprises receiving inventory data for stored quantities of at least one component utilized in the blending of the consumable product.

6. The method of claim 1, wherein receiving one or more inputs associated with a blending plan for the production of a consumable product over a predetermined time interval comprises receiving data associated with an age of at least one stored component utilized in the blending of the consumable product.

7. The method of claim 1, wherein receiving one or more inputs associated with a blending plan for the production of a consumable product over a predetermined time interval comprises receiving quality targets data associated with each of one or more raw material attributes for components utilized in producing the consumable product.

8. The method of claim 1, wherein receiving one or more inputs associated with a blending plan for the production of a consumable product over a predetermined time interval comprises receiving component targets data for various components contained within in a blended consumable product.

9. The method of claim 1, wherein receiving one or more inputs associated with a blending plan for the production of a consumable product over a predetermined time interval comprises receiving a maximum number of blended components at a blending facility for blending the consumable product.

10. The method of claim 1, wherein receiving one or more inputs associated with a blending plan for the production of a consumable product over a predetermined time interval comprises receiving storage capacity data associated with storage facilities which store various components utilized in blending the consumable product.

11. The method of claim 1, wherein receiving one or more inputs associated with a blending plan for the production of a consumable product over a predetermined time interval comprises receiving node indicator data for available storage capacity at one or more storage facilities which store various components utilized in blending the consumable product.

12. The method of claim 1, wherein receiving one or more inputs associated with a blending plan for the production of a consumable product over a predetermined time interval comprises receiving plant identification data which identifies one or more plants utilized for blending various components to produce the consumable product.

13. The method of claim 1, wherein receiving one or more inputs associated with a blending plan for the production of a consumable product over a predetermined time interval comprises receiving load-out capacity data which specifies a load-out capacity from one or more of a farm, a processor and a port utilized in providing various components which are blended to produce the consumable product.

14. The method of claim 1, wherein receiving one or more inputs associated with a blending plan for the production of a consumable product over a predetermined time interval comprises receiving transportation network data which specifies one or more routes for transporting various components, utilized in blending the consumable product, to a destination.

15. The method of claim 1, wherein receiving one or more inputs associated with a blending plan for the production of a consumable product over a predetermined time interval comprises receiving supplier component usage data from one or more suppliers of components utilized in blending the consumable product.

16. The method of claim 1, wherein receiving one or more inputs associated with a blending plan for the production of a consumable product over a predetermined time interval comprises receiving cost structure data which specifies various costs associated with producing the consumable product.

17. The method of claim 1, wherein applying, by the computer, one or more constraints to each of the one or more inputs comprises enforcing quality and component targets associated with product quality and the blending of various components for the consumable product.

18. The method of claim 1, wherein applying, by the computer, one or more constraints to each of the one or more inputs, comprises enforcing supply and demand requirements for components utilized in blending the consumable product.

19. The method of claim 1, wherein applying, by the computer, one or more constraints to each of the one or more inputs comprises enforcing a component conservation requirement by balancing produced and stored quantities of the consumable product with a supply of components, stored over at least a present and a previous time interval, the supply of components being utilized in blending the consumable product.

20. The method of claim 1, wherein applying, by the computer, one or more constraints to each of the one or more inputs comprises enforcing a capacity bound associated with capacity limitations of suppliers with respect to various components utilized in blending the consumable product.

21. The method of claim 1, wherein applying, by the computer, one or more constraints to each of the one or more inputs comprises enforcing a varietal bounds associated with various component varieties utilized in blending the consumable product.

22. The method of claim 1, wherein applying, by the computer, one or more constraints to each of the one or more inputs comprises enforcing component age and seasonal restrictions associated with the utilization of various components for blending the consumable product.

23. The method of claim 1, wherein applying, by the computer, one or more constraints to each of the one or more inputs comprises enforcing one or more business rules associated with blending requirements for producing the consumable product.

24. A computer system for optimizing a blending plan for not-from concentrate (NFC) consumable products, comprising:
a memory for storing executable program code; and
a processor, functionally coupled to the memory, the processor being responsive to computer-executable instructions contained in the program code and operative to:
receiving one or more inputs associated with a blending plan for the production of an NFC consumable product over one or more weekly time intervals;
applying one or more constraints to each of the one or more inputs; and
assessing one or more penalties in an objective function comprising the one or more inputs and the one or more constraints, the objective function utilizing the one or more constraints and the one or more penalties to generate an optimized blending plan which minimizes costs and complexity associated with the production of the NFC consumable product while maximizing quality.

25. The system of claim 24, wherein the one or more penalties comprise one or more of the following: a penalty for using a stored component in-season, a penalty for over production and a flow penalty.

26. The system of claim of claim 25, wherein the one or more penalties comprise a penalty for violating supply and demand constraints.

27. A computer-readable storage medium comprising computer executable instructions which, when executed on a computer, will cause the computer to perform a method of optimizing a blending plan for not-from-concentrate (NFC) consumable products, the method comprising:
receiving a plurality of inputs associated with a blending plan for the production of a consumable product over one or more weekly time intervals, the plurality of inputs comprising: one or more raw material attributes for components utilized in producing the NFC consumable product, supply data comprising quantities of various components provided by one or more suppliers, inventory data for stored quantities of at least one component utilized in blending the NFC consumable product, data associated with an age of at least one stored component utilized in blending the NFC consumable product, quality targets data associated with each of the one or more raw material attributes for components utilized in producing the NFC consumable product, component targets data for various components contained within the NFC consumable product, a maximum number of blended components at a blending facility for blending the NFC consumable product, storage capacity data associated with storage facilities which store various components utilized in blending the NFC consumable product, node indicator data for available storage capacity at one or more of the storage facilities, plant identification data which identifies one or more plants utilized for blending the various components to produce the NFC consumable product, load-out capacity data which specifies a load-out capacity from one or more of a farm, a processor and a port utilized in providing the various components which are blended to produce the NFC consumable product, transportation network data which specifies one or more routes for transporting the various components, utilized in blending the NFC consumable product, to a destination, receiving supplier component usage data from the one or more suppliers and receiving cost structure data which specifies various costs associated with producing the NFC consumable product;
applying a plurality of constraints to each of the one or more inputs, the plurality of constraints comprising: quality and component targets associated with product quality and blending the various components for the NFC consumable product, supply and demand requirements for the various components utilized in blending the NFC consumable product, a component conservation requirement, the component conservation requirement utilized to balance produced and stored quantities of the NFC consumable product with a supply of components, stored over at least a present and a previous time interval, the supply of components being utilized in blending the NFC consumable product, a capacity bound associated with capacity limitations of the one or more suppliers with respect to the various components utilized in blending the NFC consumable product, a varietal bounds associated with various component varieties utilized in blending the NFC consumable product, component age and seasonal restrictions associated with the utilization of the various components for blending the NFC consumable product and one or more business rules associated with blending requirements for producing the NFC consumable product; and
assessing a plurality of penalties in an objective function comprising the plurality of inputs and the plurality of constraints, the plurality of penalties comprising: a penalty for using a stored component in-season, a penalty for over production and a flow penalty, wherein the objective function utilizes the plurality of constraints and the plurality of penalties to generate an optimized blending plan which minimizes costs and complexity associated with the production of the consumable product while maximizing quality.
